(19) United States
(12) Patent Application Publication
(10) Pub. No.: US 2026/0110568 A1
(43) Pub. Date: Apr. 23, 2026

(54) INFORMATION PROCESSING DEVICE

(71) Applicant: TOYOTA JIDOSHA KABUSHIKI KAISHA, Toyota-shi (JP)

(72) Inventor: Yu UEDA, Toyota-shi (JP)

(73) Assignee: TOYOTA JIDOSHA KABUSHIKI KAISHA, Toyota-shi (JP)

(21) Appl. No.: 19/288,270

(22) Filed: Aug. 1, 2025

(30) Foreign Application Priority Data
Oct. 22, 2024 (JP) 2024-185711

(51) Int. Cl. G01H 3/06; B60K 35/28

(52) U.S. Cl. CPC G01H 3/06; B60K 35/28; B60K 2360/167

(57) ABSTRACT

The information processing device stores a database in which information indicating a frequency band of a default noise that is an abnormal sound that may be generated from the vehicle is associated with each type of a source of the default noise, and maps, based on the database and sound data including a sound generated from a vehicle that is predetermined, the frequency band of each of one or more of the default noises, and the frequency band of the candidate noise included in the sound data onto a graph in which at least one axis is assigned with a frequency.

### CROSS-REFERENCE TO RELATED APPLICATION

This application claims priority to Japanese Patent Application No. 2024-185711 filed on Oct. 22, 2024. The disclosure of the above-identified application, including the specification, drawings, and claims, is incorporated by reference herein in its entirety.

### BACKGROUND

### 1. Technical Field

The present disclosure relates to an information processing device.

### 2. Description of Related Art

There is a technique of analyzing and displaying an abnormal sound generated from a vehicle. In this regard, for example, in an inspection display method disclosed in Japanese Unexamined Patent Application Publication No. 2023-084834 (JP 2023-084834 A), sound data is acquired from the vehicle, and a kind of a component that is a source of the generated sound is specified based on the calculated sound pressure characteristic and frequency characteristic of the sound data. Then, it is determined whether the component sound is a normal sound or an abnormal sound, and an image of the sound data and frequency data is generated. Then, on the display, the specified component, vehicle model, and the determination result as to whether the component sound is a normal sound or an abnormal sound are displayed.

### SUMMARY

An object of the present disclosure is to easily visually recognize which of known abnormal sounds that is possibly generated is close to a sound to be analyzed.

An aspect of the present disclosure is an information processing device that provides information on an abnormal sound generated from a vehicle.
The information processing device includes: a storage unit configured to store a database in which information indicating a frequency band of a default noise that is an abnormal sound that is possibly generated from the vehicle is associated with each classification of a source of the default noise; and
a controller configured to execute mapping of the frequency band of each of one or more of the default noises included in the database and frequency data obtained by converting sound data including a sound generated from a predetermined vehicle into a frequency domain, onto a graph in which at least one axis is assigned with a frequency.

As another aspect, a program for causing a computer to execute an information processing method executed by the information processing device or a computer-readable storage medium storing the program in a non-transitory manner is provided.

According to the present disclosure, it is possible to easily visually recognize which of known abnormal sounds that is possibly generated is close to a sound to be analyzed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing an outline of a graph displayed by a server device according to an embodiment;

FIG. 2 is a diagram showing components of the server device according to the embodiment;

FIG. 3 is a flowchart of processing executed by the server device according to the embodiment;

FIG. 4 is a diagram showing the graph displayed by the server device according to the embodiment;

FIG. 5 is a flowchart of processing executed by a server device in the modification; and

FIG. 6 is a diagram showing a graph displayed by a server device according to a second modification.

### DETAILED DESCRIPTION OF EMBODIMENTS

### Outline

In the related art, there is a need for a technique for discriminating an abnormal sound generated from a vehicle.

In this regard, there is a technique for analyzing an abnormal sound generated from a vehicle to be inspected during a stop or traveling and displaying what kind of abnormal sound is.

For example, an abnormal sound analysis device in the related art can analyze a frequency band of an abnormal sound included in sound data collected from the vehicle during traveling and display a component of the vehicle that may be a source of the abnormal sound, together with a probability of actually being the source.

Specifically, the abnormal sound analysis device in the related art acquires the sound data from the vehicle during traveling by a sound pressure visualization device, and estimates a component that is the source of the abnormal sound by specifying a part of the vehicle in which the abnormal sound is generated. In this case, the abnormal sound analysis device can display the name of the component that is the source of the abnormal sound and the probability that the component is the source of the abnormal sound. For example, the abnormal sound analysis device can output a display such as “transmission gear noise 82%” or “transmission oil pump 10%” as the estimated source of the abnormal sound.

However, there is room for improvement in the display method in the related art. For example, when a certain abnormal sound is generated and there are a plurality of the sources of the abnormal sound that may correspond, there is a need to grasp at a glance which frequency band of the abnormal sound is most likely to correspond to the frequency band of the abnormal sound generated from any of the sources. In a method of listing and displaying a source of generation that may be a target along with a probability, as in the related art, when a part of a condition that is predetermined for determining whether the source of generation is a target is changed, the displayed source of generation and the probability are changed to a completely different source of generation and a probability. Therefore, the originally displayed source may not be displayed at all. In this case, it is difficult for a user to consistently grasp all the sources that may correspond. However, it is desirable that the user can consistently grasp the source that may correspond at a glance by integrating various traveling conditions that are changed at any time when the abnormal sound is generated.

An information processing device according to an aspect of the present disclosure is the information processing device that provides information on an abnormal sound generated from a vehicle, and the information processing device includes a storage unit configured to store a database in which information indicating a frequency band of a default noise that is an abnormal sound that may be generated from the vehicle is associated with each type of a source of the default noise; and a controller configured to execute mapping of the frequency band of each of one or more of the default noises included in the database and frequency data obtained by converting sound data including a sound generated from a vehicle that is predetermined into a frequency domain onto a graph in which at least one axis is assigned with a frequency.

The default noise is the abnormal sound that may be generated from the vehicle. The default noise is not limited to the abnormal sound actually generated, and includes all the abnormal sounds that may be generated.

The frequency data is data obtained by converting the sound data including a sound generated from the vehicle that is predetermined into the frequency domain. The frequency data can be obtained, for example, by performing Fourier transform on the sound data. The sound generated from the vehicle that is predetermined is, for example, a sound including a noise generated from the vehicle during traveling.

The controller converts the sound generated from the vehicle that is predetermined into the frequency domain, and maps the frequency band of the sound generated from the vehicle and the frequency band corresponding to the default noise included in the database onto the graph in which at least one axis is assigned with the frequency.

With such a configuration, the information processing device according to the present disclosure can easily visually recognize which of known abnormal sounds that may be generated is close to the sound that is generated from the vehicle.

In addition, the controller may be configured to emphasize, in the graph, when a frequency band, included in the frequency data, having a volume equal to or greater than a value that is predetermined overlaps the frequency band of the default noise, the corresponding domain as compared to other domains.

As a result, the information processing device according to the present disclosure can easily present to the user that the frequency band of the sound generated from the vehicle that is predetermined matches the frequency band of the default noise.

In addition, a plurality of the default noises may be noises in which frequency bands change according to a traveling speed of the vehicle, and the database may be configured to store a relationship between the frequency bands of the default noises and the traveling speed of the vehicle.

In addition, the sound data may be associated with the traveling speed of the vehicle, and the controller may be configured to update information indicating the frequency band of the default noise shown in the graph to information indicating the frequency band according to the traveling speed of the vehicle.

With such a configuration, even in a case where the frequency band of the default noise is changed according to the traveling speed of the vehicle, the default noise in an appropriate frequency band can be displayed.

In addition, the controller may calculate the frequency band of the default noise based on the traveling speed of the vehicle.

As a result, the information processing device according to the present disclosure can accurately obtain the frequency band of the default noise.

Hereinafter, specific embodiments of the present disclosure will be described with reference to the drawings. Unless otherwise specified, the hardware configuration, module configuration, functional configuration, and the like described in each embodiment are not intended to limit the technical scope of the disclosure.

### Embodiment

### Outline of Processing Performed by Server Device

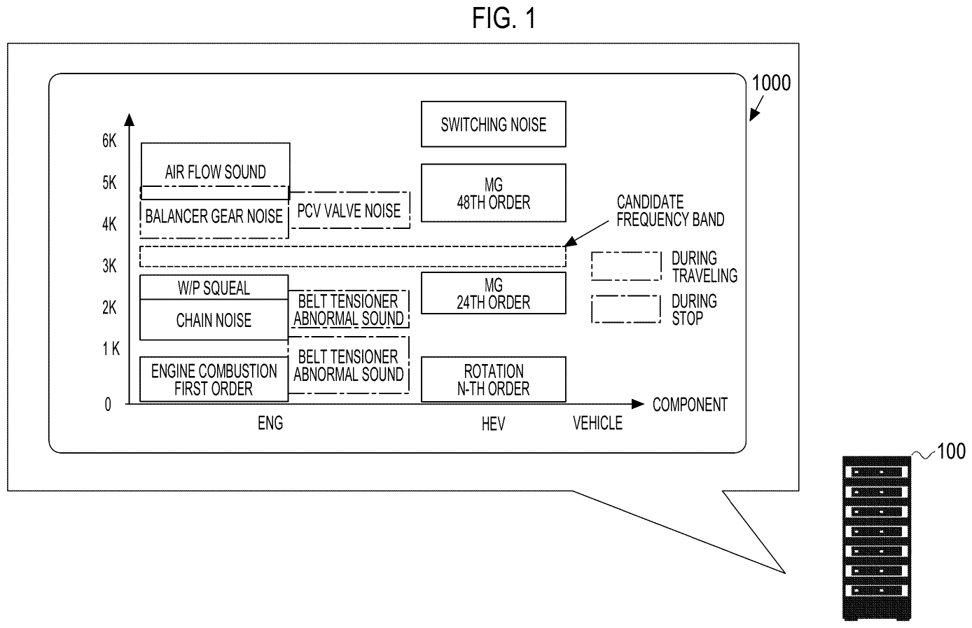

An outline of processing executed by a server device according to the embodiment will be described with reference to FIG. 1. FIG. 1 is a diagram showing an outline of a graph displayed by the server device according to the embodiment. An information processing device according to an aspect of the present disclosure is realized as a server device 100.

The server device 100 displays a graph 1000. The graph 1000 represents a graph indicating default noises and the frequency band of the sound that is a candidate for the noise (abnormal sound) generated from the vehicle. The graph 1000 is, for example, a map in which the vertical axis represents the frequency and the horizontal axis represents the type of the component. Specifically, on the graph 1000, a rectangular shape is displayed in a domain where the type of the component that is the source of the specific abnormal sound and the frequency band of the specific abnormal sound intersect. The frequency may be displayed from 0 Hz to 6000 Hz, and the types of the components may be divided into an engine system (ENG in FIG. 1), a drive system (HEV in FIG. 1), and a vehicle system (vehicle body system) (vehicle in FIG. 1). In each of the types of the components, a plurality of types of abnormal sounds is defined for each frequency. For example, in the engine system, an air flow sound, a balancer gear noise, a chain noise, and the like are defined.

In addition, the display method of the types of abnormal sounds defined as described above may be changed depending on whether the abnormal sound is generated during the stop or during traveling. For example, the abnormal sound generated during the stop may be displayed in a rectangle represented by a one-dot chain line, such as the belt tensioner abnormal sound, and the abnormal sound generated during the traveling may be displayed in a rectangle represented by a two-dot chain line, such as the balancer gear noise.

As shown in the graph 1000, the candidate frequency band that is the frequency band of the sound actually generated from the vehicle may be indicated by a broken line at a position of the corresponding frequency. The candidate frequency band can be, for example, a frequency band having a volume equal to or greater than a value that is predetermined among sounds generated from the vehicle.

As shown in FIG. 1, when there is no abnormal sound (default noise) corresponding to the frequency of the candidate frequency band, the rectangle with the broken line indicating the candidate frequency band does not overlap any rectangle indicating the default noise. When such a display is made in the graph 1000, the user can grasp that the sound generated from the vehicle does not correspond to any of the known abnormal sounds.

On the other hand, when the candidate frequency band overlaps the rectangle corresponding to any of the default noises, the user can visually grasp that the sound generated from the vehicle is the known abnormal sound.

Therefore, the server device 100 according to the embodiment can provide the relationship between the frequency band of the sound to be analyzed generated from the vehicle and the frequency band of the known abnormal sound that may be generated in an easily visually recognizable manner.

### Configuration of Server Device

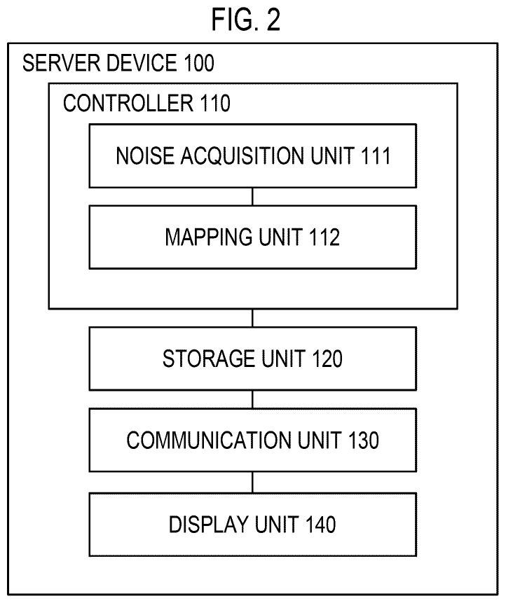

Next, a hardware configuration and a software configuration of a system including the server device 100 will be described. FIG. 2 is a diagram showing components of the server device 100 according to the embodiment.

The server device 100 can be configured as a computer including a processor (CPU, GPU, or the like), a main storage device (RAM, ROM, or the like), and an auxiliary storage device (EPROM, hard disk drive, removable media, or the like). The auxiliary storage device stores an operating system (OS), various programs, various tables, and the like, and by executing the program stored in the auxiliary storage device, each of the functions (software modules) that satisfy a purpose that is predetermined described later can be realized. Note that a part or all of the functions may be realized as a hardware module by a hardware circuit, such as an ASIC or an FPGA.

The server device 100 includes a controller 110, a storage unit 120, a communication unit 130, and a display unit 140.

The controller 110 is an arithmetic unit that realizes various functions of the server device 100 by executing a program that is predetermined. The controller 110 can be realized by a hardware processor, such as a CPU. In addition, the controller 110 may be configured to include a RAM, a read only memory (ROM), a cache memory, and the like.

In the present embodiment, the controller 110 of the server device 100 includes two software modules, that is, a noise acquisition unit 111 and a mapping unit 112. Each of the software modules may be realized by the controller 110 (CPU or the like) executing the program stored in the storage unit 120. Information processing executed by the software module is equivalent to information processing executed by the controller 110 (CPU or the like).

The noise acquisition unit 111 acquires sound data including a sound generated from the vehicle while the server device 100 is operating. In addition, the noise acquisition unit 111 records the acquired sound data generated from the vehicle in the storage unit 120.

The mapping unit 112 maps the frequency band of the sound data including the sound generated from the vehicle, acquired by the noise acquisition unit 111, and the frequency band of the default noise on the graph in which the frequency is represented on at least one axis. The frequency band of the default noise is included in the database stored in the storage unit 120. Here, the default noise is an abnormal sound that may be generated from the vehicle. The database includes information indicating frequency bands of the default noises. The mapping unit 112 performs processing of analyzing (frequency conversion) the sound data including the sound generated from the vehicle, acquired by the noise acquisition unit 111, to acquire a frequency band of a sound having a volume equal to or greater than a value that is predetermined (candidate frequency band) in the sound data. It can be said that a sound having a volume equal to or greater than a value that is predetermined in the sound data is a candidate for the default noise. In addition, the mapping unit 112 acquires data indicating a frequency band of default noise or the like that is the abnormal sound that may be generated from the vehicle from a database stored in the storage unit 120 (described later).

The storage unit 120 is a unit that stores information, and is configured by a storage medium such as a RAM, a magnetic disk, or a flash memory. The storage unit 120 stores a program executed by the controller 110, data used by the program, and the like.

The communication unit 130 is a wireless communication interface that connects the server device 100 to the external network. The communication unit 130 is configured to communicate with an external device, for example, via a wireless LAN, a cellular communication network such as 3G, 4G, or 5G.

The display unit 140 is a display that displays the graph 1000. The display unit 140 may be a touch panel display, a liquid crystal display, or an organic electro-luminescence (EL) display.

The configuration shown in FIG. 2 is an example, and all or a part of the illustrated functions may be executed using a circuit designed for exclusive use. In addition, the program may be stored or executed by a combination of a main storage device and an auxiliary storage device other than the methods illustrated.

### Processing of Server Device

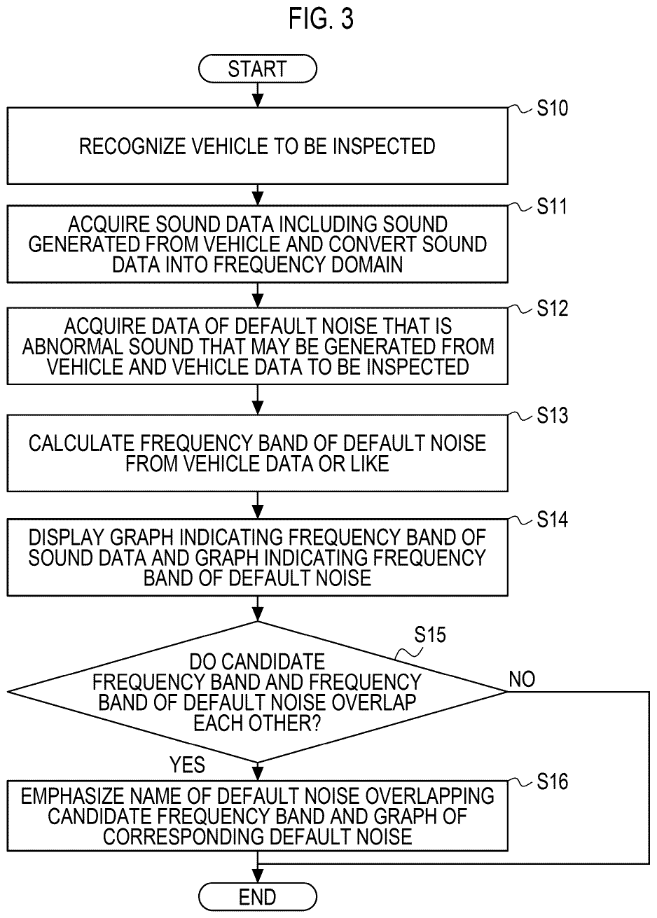

Next, specific contents of the processing executed by the server device 100 according to the aspect of the present disclosure will be described. FIG. 3 is a flowchart of the processing executed by the server device 100 according to the embodiment. In FIG. 3, the processing of mapping both the frequency band of the sound acquired from the vehicle and the frequency band of the default noise on the graph by the server device 100 will be described.

The server device 100 starts the operation started from S10 when the operation of starting the analysis of the abnormal sound by the sound for the server device 100 is received. When the server device 100 uses the sound generated from the vehicle in real time for the analysis of the abnormal sound, the server device 100 may start the processing in conjunction with the start of the vehicle.

First, in S10, the noise acquisition unit 111 recognizes the vehicle to be inspected. Specifically, the noise acquisition unit 111 may acquire the ID of the vehicle to be inspected by using the CAN communication or the like.

Next, in S11, the noise acquisition unit 111 of the server device 100 acquires sound data including a sound generated from the vehicle and converts the sound data into the frequency domain. Here, a frequency band of a sound having a volume equal to or greater than a value that is predetermined among the sounds generated from the vehicle is referred to as a candidate frequency band. In S11, the mapping unit 112 analyzes the conversion result by the noise acquisition unit 111 to acquire a frequency band of a sound having a volume equal to or greater than a value that is predetermined (candidate frequency band) in the sound data.

Next, in S12, the mapping unit 112 acquires data indicating the frequency band of the default noise that is the abnormal sound that may be generated from the vehicle and data corresponding to the vehicle recognized in S10. Specifically, the mapping unit 112 refers to the database stored in the storage unit 120 to acquire data indicating the frequency band of the default noise. The mapping unit 112 acquires data indicating the type, the number of years of use, the current or past traveling state (traveling speed, acceleration, traveling direction, and the like), and the like of the vehicle to be inspected as the vehicle data to be inspected. The data indicating the current or past traveling state is associated with the sound data acquired in S11.

Next, in S13, the mapping unit 112 calculates an assumed frequency band of the generated default noise based on the vehicle data acquired by the noise acquisition unit 111. For example, the mapping unit 112 generates data indicating the structure of the vehicle body of the vehicle to be inspected based on data indicating the type of the vehicle to be inspected. The mapping unit 112 may calculate a frequency band of the default noise that is assumed to be generated based on data indicating the structure of the vehicle body of the vehicle to be inspected.

The frequency band of the default noise may be calculated each time based on the data related to the vehicle as described above, or may be used by using the data stored in the database.

Next, in S14, the mapping unit 112 displays a graph indicating the frequency band of the sound data and a graph indicating the frequency band of the default noise. Specifically, the mapping unit 112 maps a frequency band of a sound having a volume equal to or greater than a value that is predetermined (candidate frequency band) in sound data including a sound generated from the vehicle to be inspected acquired by the noise acquisition unit 111 on a graph in which the frequency is represented on at least one axis. The mapping unit 112 maps each of the frequency bands of the default noises included in the database stored in the storage unit 120 on the same graph. At this time, the mapping unit 112 may gray out or hide the default noise determined not to be generated or to be generated with a significantly low possibility on the graph based on the vehicle data or the like.

Next, in S15, the mapping unit 112 determines whether the frequency band of the sound having the volume equal to or greater than the value that is predetermined (candidate frequency band) and the frequency band of the default noise overlap each other in the sound data acquired by the noise acquisition unit 111. In the present step, in a case where the mapping unit 112 determines that the frequency band of the sound having the volume equal to or greater than the value that is predetermined (candidate frequency band) included in the sound data including the sound generated from the vehicle overlaps the frequency band of the default noise, the determination is affirmative.

In the present step, in a case where the determination is affirmative, the processing transitions to S16.

In the present step, in a case where the determination is negative, the processing ends.

When the processing transitions to S16, the mapping unit 112 emphasizes the name of the default noise overlapping the candidate frequency band and the graph indicating the frequency band of the default noise.

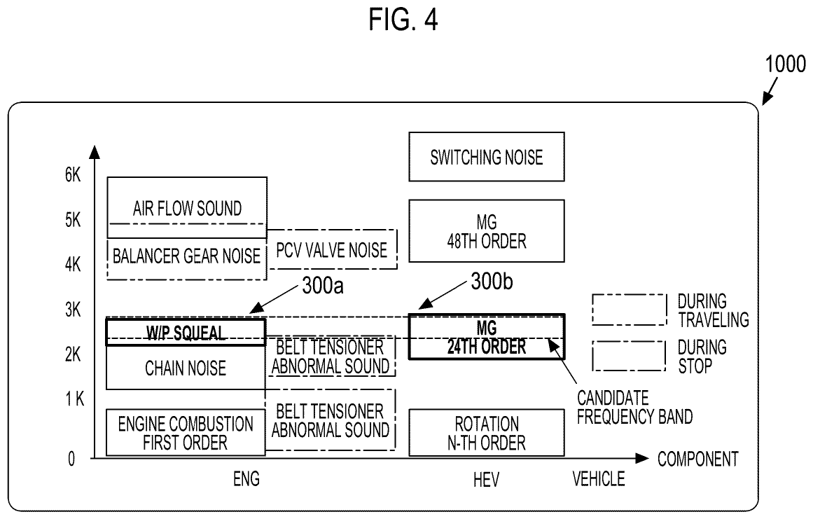

FIG. 4 is a diagram showing the graph displayed by the server device 100 according to the embodiment. The mapping unit 112 displays the graph 1000 as shown in FIG. 4 in S14 to S16 described in FIG. 3.

The graph 1000 represents a graph indicating default noises and a frequency band of a sound having a volume equal to or greater than a value that is predetermined (candidate frequency band) in sound data including a sound generated from the vehicle. The graph 1000 is, for example, a map in which the vertical axis represents the frequency and the horizontal axis represents the type of the component. Specifically, on the graph 1000, a rectangular shape is displayed in a domain where the type of the component that is the source of each of the default noises and the frequency band of each of the default noises intersect. The frequency may be displayed from 0 Hz to 6000 Hz, and the types of the components may be divided into an engine system, a drive system, and a vehicle system (vehicle body system). In each of the types of the components, the types of abnormal sounds are displayed for each frequency band. For example, in the engine system, an air flow sound, a balancer gear noise, a chain noise, and the like are displayed.

In addition, the display method of the types of abnormal sounds displayed as described above may be changed depending on whether the abnormal sound is generated during the stop or during traveling. For example, the abnormal sound generated during the stop may be displayed in a rectangle represented by a one-dot chain line, such as the belt tensioner abnormal sound, and the abnormal sound generated during the traveling may be displayed in a rectangle represented by a two-dot chain line, such as the balancer gear noise.

Then, as shown in the graph 1000, a frequency band of a sound having a volume equal to or greater than a value that is predetermined (candidate frequency band) in the sound data including the sound generated from the vehicle may be indicated by a broken line at a position of the corresponding frequency band. As shown in FIG. 1, in a case where there is no default noise corresponding to the candidate frequency band, the rectangle with the broken line indicating the candidate frequency band does not overlap any rectangle indicating the frequency band of the default noise.

On the contrary, in a case where there is default noise corresponding to the candidate frequency band, the rectangle with the broken line indicating the candidate frequency band overlaps any rectangle indicating the frequency band of the default noise. Then, on the graph 1000, a rectangle indicating a frequency band of the default noise that overlaps the rectangle with the broken line indicating the candidate frequency band and the name of the default noise are emphasized (300a and 300b in FIG. 4). For example, a rectangle representing the frequency band of the corresponding default noise may be indicated by a thicker line than the initial value. In the graph 1000, the default noise in the frequency band that does not overlap the candidate frequency band is represented by a line having a thickness set in the initial value.

In a case where such a display is made in the graph 1000, the user can grasp whether the sound (abnormal sound) generated from the vehicle corresponds to any of the existing abnormal sounds or does not correspond to any of the existing abnormal sounds. In addition, the user can visually grasp which of the existing abnormal sounds the abnormal sound generated from the vehicle is close to even when the sound (abnormal sound) generated from the vehicle does not correspond to the existing abnormal sound.

As described above, the server device 100 in the present embodiment analyzes the sound acquired from the vehicle to specify the frequency band of the sound, and maps the graph representing the specified frequency band and the graph representing the frequency band of the default noise stored separately. As a result, the server device 100 can provide the user with a form in which the user can easily visually recognize whether the sound to be analyzed corresponds to any of the known abnormal sounds that may be generated or is close to any of the known abnormal sounds.

### First Modification

Depending on the speed of the vehicle, the presence or absence or the frequency of the abnormal sound that is predetermined assumed to be generated from the vehicle may change. In this case, since the presence or absence of the default noise that may be generated or the assumed frequency band also changes according to the speed of the vehicle at the time of recording the sound data, it is necessary to update them each time on the graph.

Therefore, the server device 100 may calculate the frequency band of the default noise to be displayed on the graph based on the traveling speed of the vehicle to be inspected at the point of time when the sound to be analyzed is generated, and update the display position.

For example, the traveling speed of the vehicle to be inspected changes as the sound data is played. Therefore, a play button, a seek bar, or the like of the sound data may be added on the screen browsed by the user. In addition, the server device 100 may acquire the speed of the vehicle corresponding to the play position of the sound data, calculate the frequency band of the default noise, and update the display position of the default noise on the graph.

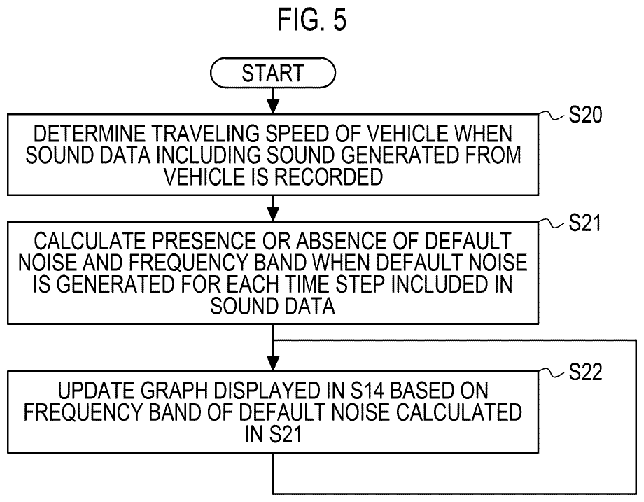

FIG. 5 is a flowchart of the processing executed by the server device 100 in the modification.

The processing of S20 to S22 is executed independently of the processing in FIG. 3.

First, in S20, the mapping unit 112 specifies the speed of the vehicle at any point in time in the sound data including the sound generated from the vehicle. In the present embodiment, the sound data and the data representing the speed in the vehicle data correspond to each other.

Next, in S21, the mapping unit 112 calculates the presence or absence of the default noise and the frequency band when the default noise is generated, based on data representing the speed of the vehicle included in the vehicle data for each time step included in the sound data.

Next, in S22, the mapping unit 112 updates the graph displayed in S14 based on the frequency band of the default noise calculated in S21. For example, the mapping unit 112 does not display a graph indicating the default noise on the graph 1000 when the vehicle is playing the sound at the time of traveling in the speed range in which the default noise is not generated. On the other hand, when the sound when the vehicle is traveling in the speed range in which the default noise is generated is being played, the mapping unit 112 displays the graph indicating the default noise in the frequency band calculated in S21. In this case, the graph showing the default noise changes according to the speed of the vehicle when the sound to be analyzed is recorded. Specifically, the position of the rectangular shape indicating the frequency band of the default noise shown on the graph 1000 is moved according to the speed of the vehicle when the sound to be analyzed is recorded. The processing of S22 is repeatedly executed. The processing of S20 and S21 is executed once each time the processing in FIG. 5 is executed.

As described above, the server device 100 according to the first modification can accurately reflect the frequency band of the default noise or the like that may change depending on the traveling speed of the vehicle to be inspected on the graph 1000.

### Second Modification

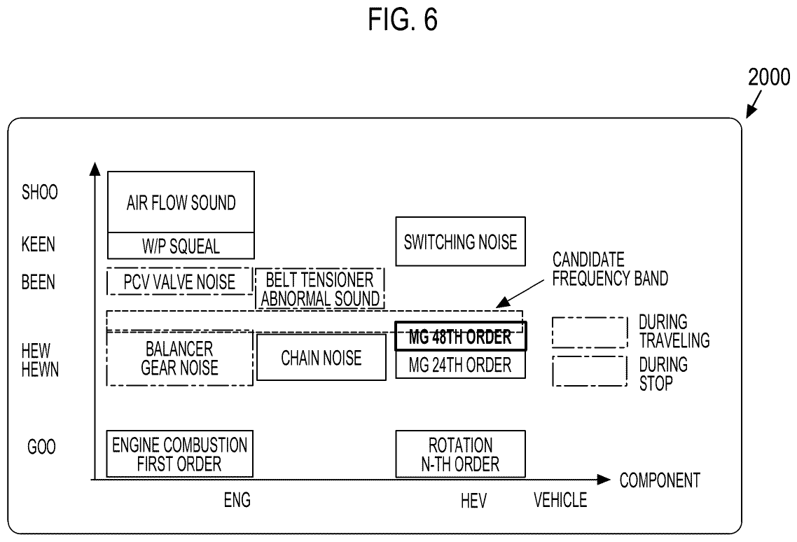

In some cases, the user may easily understand the abnormal sound generated from the vehicle by grasping the abnormal sound with onomatopoeic words close to the sound heard by the ear rather than by grasping the abnormal sound in the frequency band. Therefore, the mapping unit 112 may display an axis on which onomatopoeic words are represented instead of the axis on which the frequency of the graph 1000 is represented. FIG. 6 is a diagram showing a graph 2000 displayed by the server device according to the second modification. In the example of FIG. 6, the onomatopoeic words are represented as “goo”, “hew hewn”, “been”, “keen”, and “shoo” in order of low frequency.

In the present modification, the processing content is the same as the embodiment except that the display of the frequency in the graph is replaced with onomatopoeic expression.

Note that the expression of the onomatopoeic word in the graph 2000 in FIG. 6 is merely an example, and may be described in another expression.

### Other Modifications

The embodiment is merely an example, and the present disclosure may be implemented with appropriate modifications without departing from the gist thereof. For example, the processing and means described in the present disclosure can be implemented in any combination as long as no technical inconsistencies arise.

The mapping unit 112 may acquire data indicating the engine rotation speed (or speed) at the point in time corresponding to the time step included in the sound data. Then, the presence or absence of the default noise and the frequency band in a case where the default noise is generated may be calculated for each time step included in the sound data based on the sound data and the engine rotation speed (or the speed) corresponding to the sound data.

The present disclosure can also be realized by supplying a computer program in which the functions described in the embodiment are implemented to a computer, and reading and executing the program by one or more processors possessed by the computer. Such a computer program may be provided to the computer by a non-temporary computer-readable storage medium that can be connected to the computer's system bus, or may be provided to the computer via a network. The non-temporary computer-readable storage medium includes, for example, any type of disk, such as a magnetic disk (Floppy (Registered trademark) disk, hard disk drive (HDD), or the like), or an optical disk (CD-ROM, DVD disk, Blu-ray disk, or the like), a read-only memory (ROM), a random access memory (RAM), EPROM, EEPROM, a magnetic card, a flash memory, an optical card, and any type of media suitable for storing electronic instructions.

What is claimed is:

1. An information processing device that provides information on an abnormal sound generated from a vehicle, the information processing device comprising:
a storage unit configured to store a database in which information indicating a frequency band of a default noise that is an abnormal sound that is possibly generated from the vehicle is associated with each classification of a source of the default noise; and
a controller configured to execute mapping of the frequency band of each of one or more of the default noises included in the database and frequency data obtained by converting sound data including a sound generated from a predetermined vehicle into a frequency domain, onto a graph in which at least one axis is assigned with a frequency.

2. The information processing device according to claim 1, wherein the controller is configured to emphasize, in the graph, when a frequency band that is included in the frequency data and that has a volume equal to or greater than a predetermined value overlaps the frequency band of the default noise, a corresponding domain as compared to other domains.

3. The information processing device according to claim 1, wherein:
a plurality of the default noises is noises in which frequency bands change depending on a traveling speed of the vehicle; and
the database is configured to store a relationship between the frequency bands of the default noises and the traveling speed of the vehicle.

4. The information processing device according to claim 3, wherein:
the sound data is associated with the traveling speed of the vehicle; and
the controller is configured to update information indicating the frequency band of the default noise shown in the graph to information indicating a frequency band depending on the traveling speed of the vehicle.

5. The information processing device according to claim 4, wherein the controller is configured to calculate the frequency band of the default noise based on the traveling speed of the vehicle.
